(19) United States
(12) Patent Application Publication
(10) Pub. No.: US 2007/0220668 A1
(43) Pub. Date: Sep. 27, 2007

(54) Turkish bath

(76) Inventors: Giovanna Talocci, Roma (IT); Christian Zamagni, Cesena (IT)

Correspondence Address: Bliss McGlynn, P.C., Suite 600, 2075 West Big Beaver Road, Troy, MI, 48084, US

(21) Appl. No.: 11/388,344

(22) Filed: Mar. 24, 2006

(51) Int. Cl. A61H 33/06

(52) U.S. Cl. 4/524

(57) ABSTRACT

A Turkish bath has a steam generating device for feeding steam into a stall, user access to which is through an opening fitted with a door connected to a supporting frame, which has at least one tubular channel located substantially inside a space defined by the supporting frame, and for housing at least one electric cable and/or at least one hydraulic conduit.

The present invention relates to a Turkish bath.

More specifically, the present invention relates to a Turkish bath of the type comprising a steam generating device for feeding steam into a stall, which is defined by a masonry structure having a user entrance, and has a door for closing the entrance.

### BACKGROUND OF THE INVENTION

The masonry structure, for example, has at least one nozzle for feeding steam into the stall; a control panel for controlling operation of the Turkish bath; and a light source for illuminating the stall inside.

The control panel and the light source face the inside of the stall from respective seats formed in the masonry structure, and are powered electrically by respective electric cables housed inside the masonry structure; while the nozzle faces the inside of the stall from a further seat formed in the masonry structure, and is connected to the steam generating device by a hydraulic feed conduit.

Known Turkish baths of the type described above have various drawbacks, mainly on account of the difficulty and time involved in installing the nozzle, the control panel, and the light source, which comprises first forming the relative seats in the masonry structure, and then installing each of the electric cables and/or hydraulic conduits in relation to the relative seat.

### SUMMARY OF THE INVENTION

It is an object of the present invention to provide a Turkish bath designed to eliminate the aforementioned drawbacks, and which is cheap and easy to produce.

According to the present invention, there is provided a Turkish bath as claimed in the attached Claims.

### BRIEF DESCRIPTION OF THE DRAWINGS

A non-limiting embodiment of the present invention will be described by way of example with reference to the accompanying drawings, in which:

FIG. 1 shows a schematic interior view in perspective of a preferred embodiment of the Turkish bath according to the present invention;

FIG. 2 shows an exterior front view of a detail in FIG. 1;

FIG. 3 shows a larger-scale section along line III-III in FIG. 2.

### DETAILED DESCRIPTION OF THE INVENTION

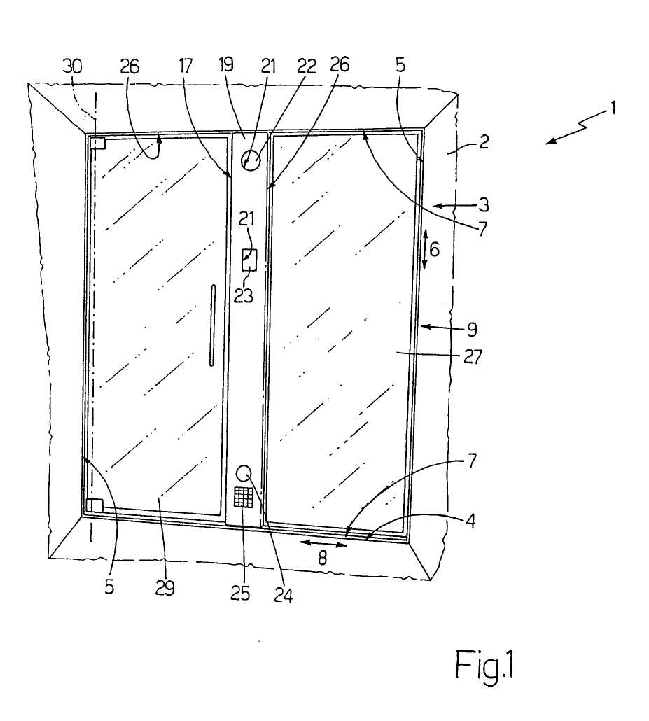

Number 1 in FIG. 1 indicates as a whole a Turkish bath comprising a masonry structure 2 defining a stall 3, which has a known steam generating device (not shown) for feeding steam into stall 3, and an opening 4 formed through structure 2 to allow access to stall 3 by the users of Turkish bath 1.

In the example shown, opening 4 is substantially rectangular, and is bounded internally by two lateral faces 5 parallel to each other and to a substantially vertical direction 6, and by two lateral faces 7 (one of which is coplanar with the floor) parallel to each other and to a substantially horizontal direction 8 crosswise to direction 6.

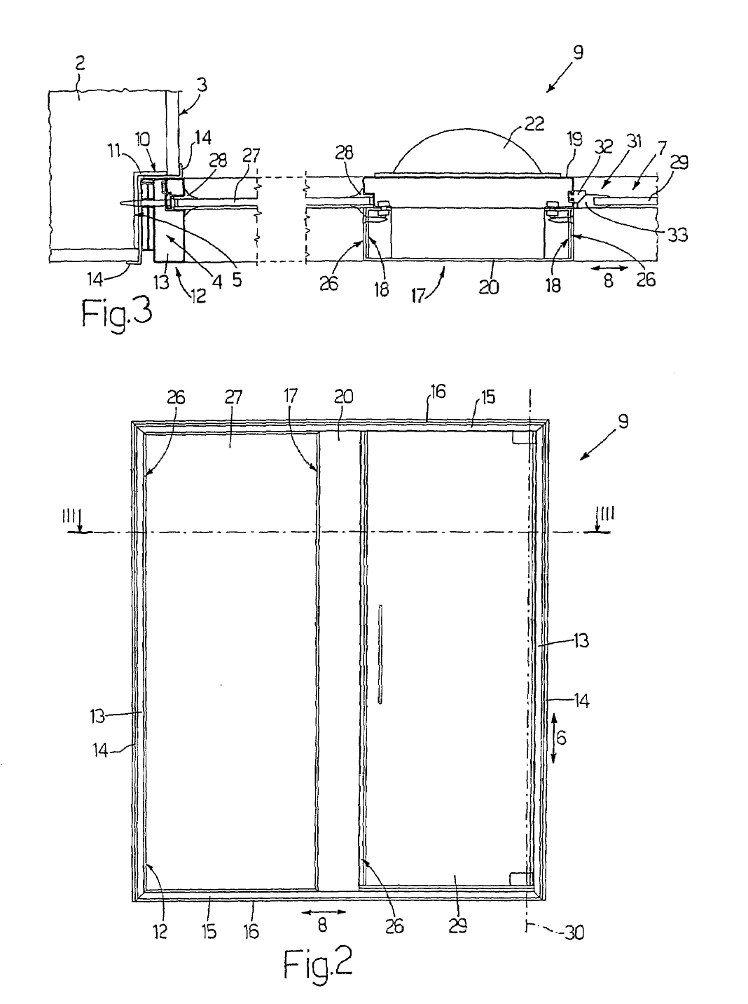

As shown in FIGS. 2 and 3, Turkish bath 1 also has a closing device 9 for closing opening 4, and which comprises an inner frame 10, in turn comprising, in the example shown, a metal annular structure 11 extending about opening 4 and fixed to faces 5 and 7 of opening 4.

A supporting frame 12 is fixed to inner frame 10, and comprises two parallel tubular posts 13, each extending in direction 6 and fixed to structure 11 at a relative face 5 with the interposition of two substantially L-shaped sections 14 projecting one inwards and one outwards of stall 3; and two parallel tubular cross members 15, each extending in direction 8 and fixed to structure 11 at a relative face 7 with the interposition of two substantially L-shaped sections 16 projecting one inwards and one outwards of stall 3.

Frame 12 also comprises a tubular equipment column 17, which extends in direction 6 and substantially inside a space defined by posts 13 and cross members 15, is mounted, in the example shown, at an intermediate point along cross members 15, and in turn comprises two vertical, substantially L-section posts 18 aligned with each other in direction 8 and fixed at their opposite free ends to cross members 15.

Column 17 also comprises a substantially U-shaped first cover plate 19 fixed to posts 18 and facing inwards of stall 3; and a substantially U-shaped second cover plate 20 extending about posts 18 and facing outwards of stall 3.

With reference to FIG. 1, plate 19 has a number of (in the example shown, four) seats 21 formed through plate 19, arranged successively in direction 6, and for respectively housing a light source 22 for illuminating the inside of stall 3; a control panel 23 for controlling operation of Turkish bath 1; a nozzle 24 for feeding steam into stall 3; and a ventilation device 25 for circulating air inside stall 3 when Turkish bath 1 is turned on, and for aiding drying of the inside of stall 3 when Turkish bath 1 is turned off.

Light source 22, control panel 23, and ventilation device 25 are powered electrically by respective electric cables (not shown) which project from masonry structure 2 into column 17 through metal structure 11 of inner frame 10 and top horizontal cross member 15 of frame 12; while nozzle 24 is connected to the steam generating device (not shown) by a hydraulic feed conduit (not shown) which projects from masonry structure 2 into column 17 through metal structure 11 of inner frame 10 and top horizontal cross member 15 of frame 12.

Column 17 divides opening 4 into two enclosures 26, one of which is closed by a sheet of glass 27 fixed to frame 12 and to column 17 with the interposition of a number of seals 28 (two shown in FIG. 3), and the other of which is closed by a door 29, which is hinged to one of posts 13 of frame 12 to rotate, with respect to frame 12, about a hinge axis 30 parallel to direction 6, and is maintained in a closed position closing stall 3 by a magnetic fastening device 31 comprising a first magnetic member 32 fitted to plate 19 and parallel to direction 6, and a second magnetic member 33 fitted along a vertical edge of door 29.

It should be pointed out that door 29 is of a height, measured parallel to direction 6, approximately equal to but no greater than the height of frame 12, also measured parallel to direction 6, and has a seal (not shown) fitted along a horizontal bottom edge of door 29, and in turn having a horizontal bottom edge designed to let air, but not water, out of stall 3, and a horizontal top edge fitted in fluidtight manner to door 29 to prevent steam escaping from stall 3.

Equipment column 17 therefore provides for relatively fast, easy installation of Turkish bath 1, by virtue of light source 22, control panel 23, nozzle 24, and ventilation device 25 being mounted on column 17, and the fitter simply connecting light source 22, control panel 23, and ventilation device 25 to the relative electric cables (not shown) projecting inside column 17 from masonry structure 2, and simply connecting nozzle 24 to the relative hydraulic feed conduit (not shown) also projecting inside column 17 from masonry structure 2.

In a variation not shown, column 17 is fitted to the ends of horizontal cross members 15 of supporting frame 12, so as to define one enclosure 26 closed by door 29.

1) A Turkish bath comprising a stall (3) having an opening (4) for user access to the stall (3); steam generating means for feeding steam into the stall (3); and a closing device (9) for closing said opening (4); the closing device (9) comprising a supporting frame (12) extending about at least part of said opening (4), and a door (29) connected to the supporting frame (12) to close at least part of the opening (4); characterized in that the supporting frame (12) has at least one tubular channel (17) located substantially inside a space bounded by the supporting frame (12), and for housing at least one electric cable and/or at least one hydraulic conduit.

2) A Turkish bath as claimed in claim 1, and also comprising a masonry structure (2) defining said stall (3).

3) A Turkish bath as claimed in claim 1, wherein the tubular channel (17) supports at least one nozzle (24) for feeding steam into said stall (3), and at least one control panel (23) for controlling operation of the Turkish bath.

4) A Turkish bath as claimed in claim 1, wherein the tubular channel (17) supports at least one light source (22) for illuminating the inside of said stall (3).

5) A Turkish bath as claimed in claim 1, wherein the tubular channel (17) supports a ventilation device (25) for feeding air into said stall (3).

6) A Turkish bath as claimed in claim 1, wherein the tubular channel (17) is substantially vertical.

7) A Turkish bath as claimed in claim 1, wherein the tubular channel (17) is substantially vertical, and is substantially the same height as said supporting frame (12).

8) A Turkish bath as claimed in claim 6, wherein the tubular channel (17) comprises two vertical posts (18), and two lateral walls (19, 20) extending between the vertical posts (18) to define the tubular channel (17); a first said lateral wall (19) facing inwards of said stall (3), and a second said lateral wall (20) facing outwards of the stall (3).

9) A Turkish bath as claimed in claim 8, wherein said first lateral wall (19) supports at least one nozzle (24) for feeding steam into said stall (3), at least one control panel (23) for controlling operation of the Turkish bath, and at least one light source (22) for illuminating the inside of the stall (3).

10) A Turkish bath as claimed in claim 8, and also comprising a ventilation device (25) for feeding air into said stall (3); the ventilation device (25) being housed inside the tubular channel (17), and communicating with the stall (3) through said first lateral wall (19).

11) A Turkish bath as claimed in claim 1, and also comprising an inner frame (10), which extends along at least part of said opening (4), and is interposed between said supporting frame (12) ad the opening (4).
